(19) United States
(12) Patent Application Publication
(10) Pub. No.: US 2010/0184402 A1
(43) Pub. Date: Jul. 22, 2010

(54) MONITORING COMMUNICATION EVENTS INVOLVING A HANDSET IN REAL TIME

(76) Inventors: Yigang Cai, Naperville, IL (US); Shiyan Hua, Lisle, IL (US); Markus Hofmann, Fair Haven, NJ (US)

Correspondence Address: DUFT BORNSEN & FISHMAN, LLP, 1526 SPRUCE STREET, SUITE 302, BOULDER, CO, 80302, US

(21) Appl. No.: 12/358,101

(22) Filed: Jan. 22, 2009

(51) Int. Cl. H04M 1/66; H04M 11/00

(52) U.S. Cl. 455/405; 455/411

(57) ABSTRACT

Communication networks and methods are disclosed for allowing a party (i.e., a controlling party) to monitor the usage of a handset in real time. The handset being monitored (i.e, a reporting handset) may be involved in one or more communication events, such as initiating or terminating voice calls, initiating or terminating data sessions, sending or receiving text messages, etc. When a communication event occurs involving the reporting handset, a communication event report is generated in the reporting handset or the communication network. The communication event report is then transmitted to a controlling handset of the controlling party so that the controlling party may view the report. Because the communication event report is generated and transmitted to the controlling party responsive to the occurrence of the communication event, the report of the communication event is provided to the controlling party in real time.

### BACKGROUND OF THE INVENTION

1. Field of the Invention

The invention is related to the field of communication networks and, in particular, to monitoring communication events involving a handset in real time.

2. Statement of the Problem

Due to the popularity of mobile communications, many different types of people use mobile handsets on a daily basis. Situations may occur where one party may want to monitor the usage of mobile handsets (or fixed-line handsets) by other parties. For example, parents may allow a child to have a cellular phone, but at the same time want to monitor who the child is calling with the phone. Also, employers may issue cellular phones to their employees, but also want to monitor how the phones are being used. Parents and employers are examples of “controlling parties” that want to monitor the usage of a handset that is being used by another party.

Present communication networks provide ways of monitoring how mobile handsets or fixed-line handsets are being used. For instance, most service providers send out a monthly statement indicating the usage of a particular handset. A controlling party may then view the monthly statements to monitor how a handset was used for that month. In some mobile networks or VoIP networks, the service provider may maintain a web site indicating usage of a handset. A controlling party may access the web site to monitor how a handset is being used.

One problem however in present communication networks is that a controlling party cannot monitor the usage of a handset in real time. For instance, a controlling party may view a monthly statement for a handset, but the controlling party has to wait until the end of the month to view the statement. Also, a controlling party may view a web site indicating usage of a handset, but the web site may not be updated for hours after the actual usage of the handset. It may therefore be desirable to allow a controlling party to monitor usage of a handset in real time.

### SUMMARY OF THE SOLUTION

Embodiments of the invention solve the above and other related problems by allowing a controlling party to monitor the usage of a handset in real time. The handset being monitored, which is referred to herein as a reporting handset, may be involved in one or more communication events. Examples of communication events include initiating or terminating voice calls, initiating data sessions, sending or receiving text messages, etc. When a communication event occurs involving the reporting handset, a communication event report is generated in the reporting handset or the communication network. The communication event report is then transmitted to a controlling handset of the controlling party so that the controlling party may view the report. Because the communication event report is generated and transmitted to the controlling party responsive to the occurrence of the communication event, the report of the communication event is advantageously provided to the controlling party in real time. The controlling party may then act in a particular manner responsive to the occurrence of the communication event. For example, the controlling party may authorize or deny the communication event involving the reporting handset. This advantageously gives the controlling party more control over how the reporting handset is being used.

One embodiment of the invention comprises a communication network operable to monitor usage of a reporting handset. The communication network identifies criteria defining a communication event involving the reporting handset. The criteria define what conditions comprise a communication event in the reporting handset, such as initiation of a voice call. The communication network then monitors signaling messages for the reporting handset based on the criteria to identify an occurrence of the communication event involving the reporting handset. In response to identifying the occurrence of the communication event involving the reporting handset, the communication network generates a communication event report, and transmits the communication event report to a controlling handset. The controlling handset may then display the communication event report to a controlling party so that the controlling party may view the usage of the reporting handset.

In another embodiment, the controlling party may control whether or not the communication event is allowed to continue. To allow for this type of control, the communication network suspends the communication event involving the reporting handset. The communication network then generates an authorization request message requesting authorization of the communication event identified for the reporting handset, and transmits the authorization request message to the controlling handset. The communication network receives an authorization response message from the controlling handset indicating whether or not the communication event is authorized. If the authorization response message indicates that the communication event is authorized, then the communication network permits the communication event. If the authorization response message indicates that the communication event is not authorized, then the communication network prohibits the communication event.

Another embodiment of the invention comprises a system that supports monitoring the usage of a reporting handset. For this system, a controlling handset identifies criteria defining a communication event involving the reporting handset. The controlling handset then generates a report request message, inserts the criteria in the report request message, and transmits the report request message to the reporting handset over a communication network.

The reporting handset receives the report request message, and processes the report request message to identify the criteria. The reporting handset then monitors its activities based on the criteria to identify an occurrence of the communication event. In response to identifying the communication event, the reporting handset generates a communication event report, and transmits the communication event report to the controlling handset over the communication network.

The controlling handset receives the communication event report from the communication network, and displays the communication event report to a controlling party. As with the prior embodiment, the controlling party may then control whether or not the communication event is allowed to continue.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 is a flow chart illustrating a method of monitoring the usage of a reporting handset in an exemplary embodiment of the invention.

FIG. 3 is a flow chart illustrating a method of controlling communication events in an exemplary embodiment of the invention.

FIG. 4 illustrates a controlling handset in an exemplary embodiment of the invention.

FIG. 5 illustrates a reporting handset in an exemplary embodiment of the invention.

FIGS. 6-8 are flow charts illustrating another method of monitoring the usage of a reporting handset in an exemplary embodiment of the invention.

FIG. 9 illustrates another communication network in an exemplary embodiment of the invention.

FIG. 10 is a message diagram illustrating the monitoring of a reporting UE in an exemplary embodiment of the invention.

FIG. 11 illustrates a communication event report displayed by a controlling UE in an exemplary embodiment of the invention.

FIG. 12 is a message diagram illustrating the monitoring of a reporting UE with control by a controlling party in an exemplary embodiment of the invention.

FIG. 13 illustrates a controlling UE prompting a controlling party for authorization of a communication event in an exemplary embodiment of the invention.

FIG. 14 is a message diagram illustrating the monitoring of a reporting UE in an exemplary embodiment of the invention.

FIG. 15 is a message diagram illustrating the monitoring of a reporting UE with control by a controlling party in an exemplary embodiment of the invention.

### DETAILED DESCRIPTION OF THE INVENTION

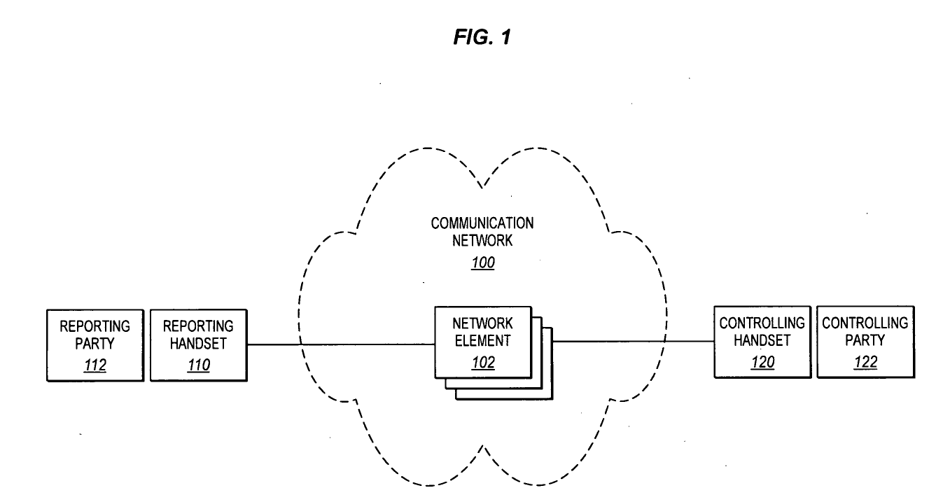

FIGS. 1-15 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

A handset as described herein comprises some type of end-user communication device that is used for voice calls, text/multimedia messaging, data sessions, or other types of communication over a telecommunication network. The handset may be a mobile device, such as a cellular phone, a mobile VoIP phone, etc. The handset may alternatively be a fixed-line device, such as a legacy phone, an Ethernet-connected VoIP phone, etc. The term “handset” may also be referred to as User Equipment (UE), an end-user terminal, or an end-user station.

As described in the Background, when one party uses a handset for communication, another party may want to monitor the usage of the handset remotely. For example, parents may allow a child to have a handset, but at the same time want to monitor the usage of the handset by the child. Also, employers may issue handsets to their employees, but also want to monitor how the handsets are being used. A party that is in a position to monitor the usage of a handset by another is referred to herein as a “controlling party”. The party that is using the handsets being monitored is referred to herein as a “reporting party”. A controlling party has some type of family relationship, business relationship, or other type of authoritative relationship over the reporting party. According to the embodiments described below, a controlling party is able to monitor the usage of a handset of a reporting party in real time.

FIG. 1 illustrates a communication network 100 in an exemplary embodiment of the invention. Communication network 100 is operable to provide communication services to a reporting handset 110 operated by a reporting party 112. For example, reporting handset 110 may initiate or terminate voice calls over communication network 100, initiate data sessions over communication network 100, send or receive text/multimedia messages over communication network 100, etc.

Communication network 100 may comprise a mobile network, such as a CDMA network or a UMTS/GSM network, or may comprise a fixed-line network, such as a PSTN. Communication network 100 may also comprise a circuit-switched network or a packet network. For example, communication network 100 may comprise an IP Multimedia Subsystem (IMS) network in one embodiment. Communication network 100 is shown as generally including one or more network elements 102. A network element comprises any system, server, or device operable to provide a communication service within communication network 100. Those skilled in the art will appreciate that a network element 102 may comprise a switch (or MSC), an HLR, etc, in a circuit-switched network. Network element 102 may alternatively comprise a Serving-Call Session Control Function (S-CSCF), a Home Subscriber Server (HSS), or an application server in an IMS network.

Communication network 100 is also connected to a controlling handset 120 operated by a controlling party 122 that has requested to be notified of communication events involving reporting handset 110. Communication network 100 provides a service that allows controlling party 122 to monitor the usage of reporting handset 110 in real time. Although the term “handset” is used to describe the equipment used by controlling party 122, those skilled in the art will appreciate that controlling party 122 may use other types of devices to monitor the usage of reporting handset 110, such as a computer.

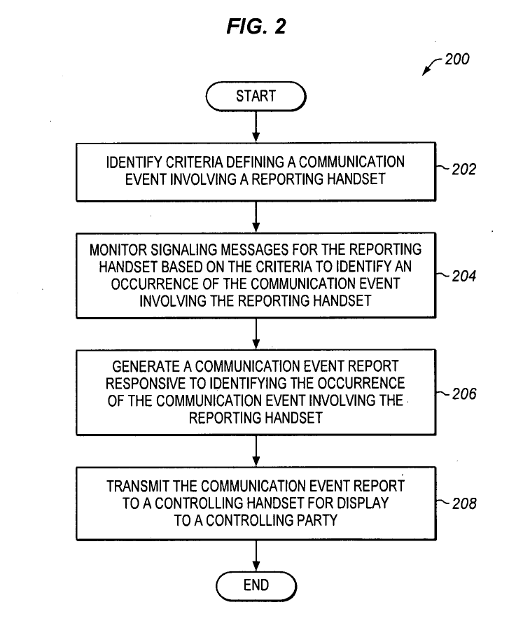

FIG. 2 is a flow chart illustrating a method 200 of monitoring the usage of reporting handset 110 in an exemplary embodiment of the invention. The steps of method 200 will be described with reference to communication network 100 in FIG. 1. The steps of the flow chart in FIG. 2 are not all inclusive and may include other steps not shown.

In step 202, network element 102 within communication network 100 identifies criteria defining a communication event involving reporting handset 110. A communication event comprises an action or actions performed by reporting handset 110 to communicate over communication network 100. Examples of communication events include initiating or terminating voice calls, initiating data sessions, sending or receiving text messages, etc. Criteria for a communication event comprise conditions, parameters, or any other information defining one or more communication events. As an example, criteria for a communication event may define a type of communication as a communication event, such as initiation or termination of a voice call, initiation of a data session, sending or receiving a text/multimedia message, etc. Criteria for a communication event may further define an originator or recipient of a communication, such as initiation of a voice call to a particular directory number, termination of a voice call from a particular directory number, initiation of a text/multimedia message to a particular directory number, a data connection to a specific destination, etc. Criteria for a communication event may further define a location of reporting handset 110. The criteria may be pre-provisioned in communication network 100 by a service provider or controlling party 122, or may be dynamically defined by controlling party 122.

In step 204, network element 102 monitors signaling messages for reporting handset 110 based on the criteria to identify an occurrence of the communication event involving reporting handset 110. Assume for example, that the criteria define a communication event as initiation of a voice call. If reporting handset 110 transmits a SIP INVITE to communication network 100 to initiate a call, then network element 102 (e.g., an S-CSCF) processes the SIP INVITE to identify an occurrence of a communication event.

Steps 202 and 204 of method 200 may be performed responsive to a specific request from controlling handset 120. For example, network element 102 may receive a SIP SUBSCRIBE message from controlling handset 120 requesting to be notified of a communication event involving reporting handset 110. In response to the SIP SUBSCRIBE, network element 102 identifies the criteria (step 202) and begins monitoring the signaling messages for reporting handset 110 (step 204). Alternatively, network element 102 may be pre-provisioned to automatically identify the criteria (step 202) and monitor the signaling messages for reporting handset 110 (step 204).

In step 206, network element 102 generates a communication event report responsive to identifying the occurrence of the communication event involving reporting handset 110. The communication event report includes information indicating that the communication event has occurred. The communication event report may also include other information about the communication event, such as a calling party number, a called party number, a calling party name, a called party name, a location of reporting device 110, content of the event, etc. If the communication event comprises a text/multimedia message, then the communication event report may include the content of the message. If the communication event comprises a data session, then the communication event report may include the content of the session, or a location of the content, such as a URL.

In step 208, network element 102 transmits the communication event report to controlling handset 120 for display to controlling party 122. In response to receiving the communication event report, controlling handset 120 processes the information in the report, and displays the information to controlling party 122 through a user interface. Because controlling handset 120 receives the communication event report in response to communication network 100 detecting the occurrence of the communication event, controlling handset 120 in effect receives the communication event report in real time.

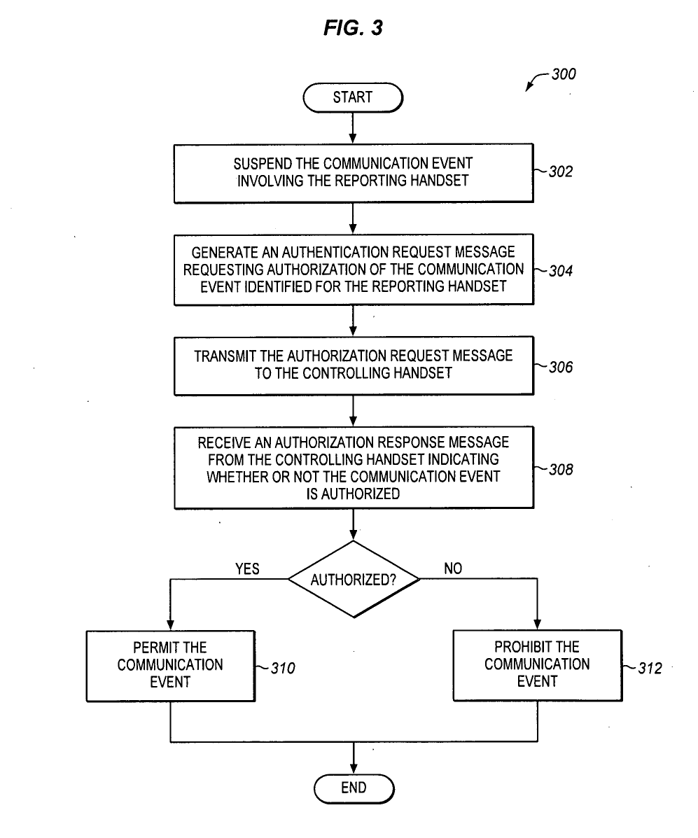

Because controlling handset 120 receives the communication event report in real time, controlling party 122 may be able to act upon the communication event immediately. For example, controlling party 122 may control whether or not the communication event is allowed to continue, which is illustrated in FIG. 3.

FIG. 3 is a flow chart illustrating a method 300 of controlling communication events in an exemplary embodiment of the invention. The steps of method 300 will be described with reference to communication network 100 in FIG. 1. The steps of the flow chart in FIG. 3 are not all inclusive and may include other steps not shown.

In step 302, network element 102 suspends the communication event involving reporting handset 110. For example, if the communication event comprises initiation of a voice call from reporting handset 110, then network element 102 suspends set up of the voice call. Upon suspending the communication event, network element 102 may provide an announcement or send a message to reporting UE 110 and/or controlling handset 120 indicating that the communication event has been suspended. In step 304, network element 102 generates an authorization request message requesting authorization of the communication event identified for reporting handset 110. In step 306, network element 102 transmits the authorization request message to controlling handset 120. Those skilled in the art will appreciate that the authorization request message may be bundled with the communication event report.

In response to the authorization request message, controlling handset 120 prompts controlling party 122 about whether the communication event is authorized. For example, if the communication event comprises a voice call, then controlling handset 120 prompts controlling party 122 as to whether the voice call is authorized. The prompt by controlling handset 120 may include information about the communication event, which was included in the communication event report. For example, if the communication event comprises a voice call to Randy Smith, then controlling handset 120 prompts controlling party 122 as to whether the voice call to Randy Smith is authorized, and may include a cost of the call being placed. If the communication event comprises a text/multimedia message, then controlling handset 120 prompts controlling party 122 as to whether the text/message is authorized. The communication event report may include the actual text/multimedia message for controlling party 122 to view. Based on the input from controlling party 122, controlling handset 120 generates an authorization response message, and transmits the authorization response message to communication network 100.

In step 308, network element 102 receives the authorization response message from controlling handset 120 indicating whether or not the communication event is authorized. If the authorization response message indicates that the communication event is authorized, then network element 102 permits the communication event involving the reporting handset in step 310. For example, if the communication event comprises initiation of a voice call, then network element 102 allows set up of the voice call to continue. If the authorization response message indicates that the communication event is not authorized, then network element 102 prohibits the communication event involving the reporting handset in step 312. For example, if the communication event comprises initiation of a voice call, then network element 102 blocks the set up of the voice call.

Because communication network 100 seeks authorization from controlling party 122 before the communication event is performed, controlling party 122 is able to control whether or not the communication event is performed. As a result, controlling party 122 may be able to control whether or not reporting party 112 can place or receive a call through reporting handset 110. Controlling party 122 may also be able to control whether or not reporting party 112 can place a call to certain directory numbers or called parties through reporting handset 110, such as to long distance numbers or high-toll numbers (i.e., 1-900 numbers).

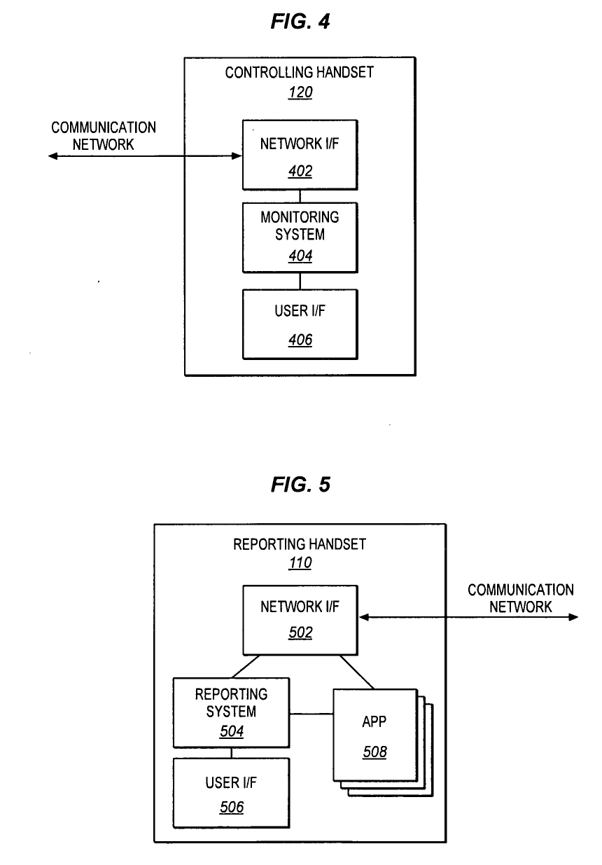

In the embodiment shown in FIG. 2, communication network 100 generates the communication event report and provides the report to controlling handset 120. In another embodiment, reporting handset 110 may generate the communication event report and provide the report to controlling handset 120. This embodiment is illustrated in FIGS. 4-8.

FIG. 4 illustrates controlling handset 120 in an exemplary embodiment of the invention. Controlling handset 120 includes a network interface 402, a monitoring system 404, and a user interface 406. Network interface 402 comprises any components or devices operable to communicate with communication network 100. Network interface 402 is operable to communicate signaling messages, such as SIP messages, and bearer communications, such as RTP packets. Network interface 202 may comprise a wireline interface or a wireless interface.

Monitoring system 404 comprises any components, devices, processors, or applications operable to monitor the usage of a reporting handset 110. For example, monitoring system 404 may comprise a specialized monitoring application that is running on a processor in controlling handset 120. The monitoring application provides the functions in controlling handset 120 in order to allow controlling party 122 to monitor usage of reporting handset 110, and possibly to control events involving reporting handset 110. The monitoring application may store criteria that define communication events for reporting party 110, may generate user interface screens in order to interact with controlling party 120, and may perform any other functions to allow controlling party 122 to monitor usage of reporting handset 110.

User interface 406 comprises any components or devices operable to receive input from a user, such as a keypad, a pointing device, etc, and/or convey content to the user, such as a display, a speaker, etc.

FIG. 5 illustrates reporting handset 110 in an exemplary embodiment of the invention. Reporting handset 110 includes a network interface 502, a reporting system 504, a user interface 506, and one or more call/event-related applications 508. Network interface 502 comprises any components or devices operable to communicate with communication network 100. Network interface 502 may comprise a wireline interface or a wireless interface.

Reporting system 504 comprises any components, devices, processors, or applications operable to report one or more communication events to a controlling handset 120. For example, reporting system 504 may comprise a specialized reporting application that is running on a processor in reporting handset 110. The reporting application provides the functions in reporting handset 110 in order to report communication events. The reporting application may process criteria that define communication events, and then monitor activities of other applications 508 in reporting handset 110 to identify the occurrence of one or more communication events. The reporting application may then report the communication events to controlling handset 120.

User interface 506 comprises any components or devices operable to receive input from a user, such as a keypad, a pointing device, etc, and/or convey content to the user, such as a display, a speaker, etc. Applications 508 represent one or more call/event-related applications that are typically programmed into a handset. For example, application 508 may comprise a voice call application that allows reporting handset 110 to initiate or terminate a voice call. Application 508 may comprise a text/multimedia messaging application that allows reporting handset 110 to send or receive text/multimedia messages. Application 508 may comprise a data application that allows reporting handset 110 to access the internet or initiate other types of data sessions.

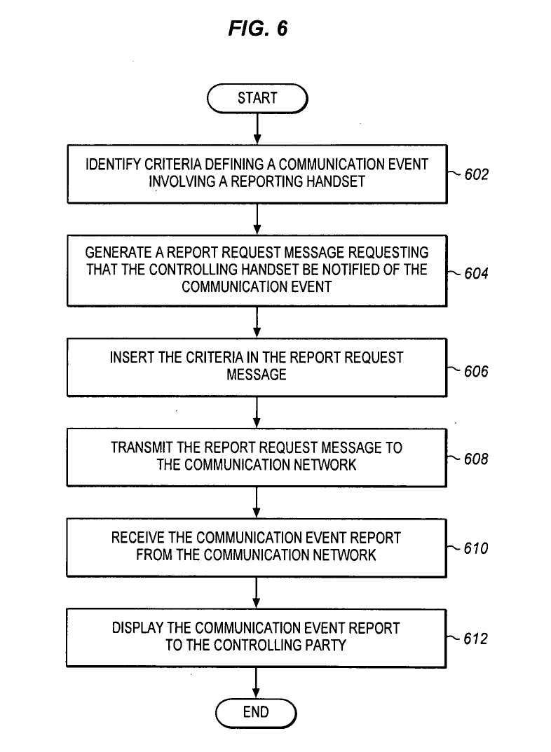

FIGS. 6-8 are flow charts illustrating a method of monitoring the usage of reporting handset 110 in an exemplary embodiment of the invention. The steps of the method will be described with reference to communication network 100 in FIG. 1, controlling handset 120 in FIG. 4, and reporting handset 110 in FIG. 5. The steps of the flow chart in FIGS. 6-8 are not all inclusive and may include other steps not shown.

In FIG. 6, monitoring system 404 in controlling handset 120 identifies criteria defining a communication event involving reporting handset 110 for which controlling party 122 desires to be notified in step 602. Monitoring system 404 may be pre-provisioned with the criteria in one embodiment. In another embodiment, monitoring system 404 may display a screen (through user interface 406) to controlling party 122, which allows controlling party 122 to dynamically define the criteria. For example, monitoring system 404 may display a screen that allows controlling party 122 to define that all incoming and outgoing voice calls involving reporting handset 110 be monitored.

In step 604, monitoring system 404 generates a report request message requesting that controlling handset 120 be notified of the communication event. Monitoring system 404 then inserts the criteria in the report request message in step 606. One example of a report request message comprises a SIP SUBSCRIBE message that requests notification of the communication event defined by the criteria. Network interface 402 then transmits the report request message to communication network 100 in step 608.

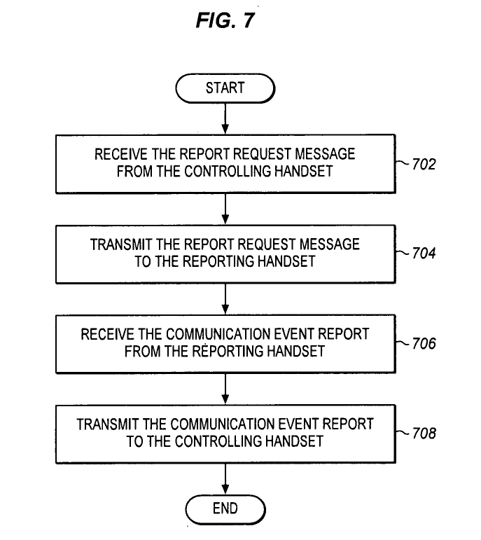

In FIG. 7, network element 102 receives the report request message in step 702. In response to the report request message, network element 102 transmits the report request message to reporting handset 110 in step 704. As an alternative to receiving the report request message from controlling handset 120, network element 102 may generate the report request message based on pre-provisioned information regarding controlling party 122. For example, communication network 100 may be pre-provisioned with criteria defining one or more communication events to monitor involving reporting handset 110. Thus, network element 102 may automatically generate the report request message, and transmit the report request message to reporting handset 110 instead of receiving the report request message from controlling handset 120.

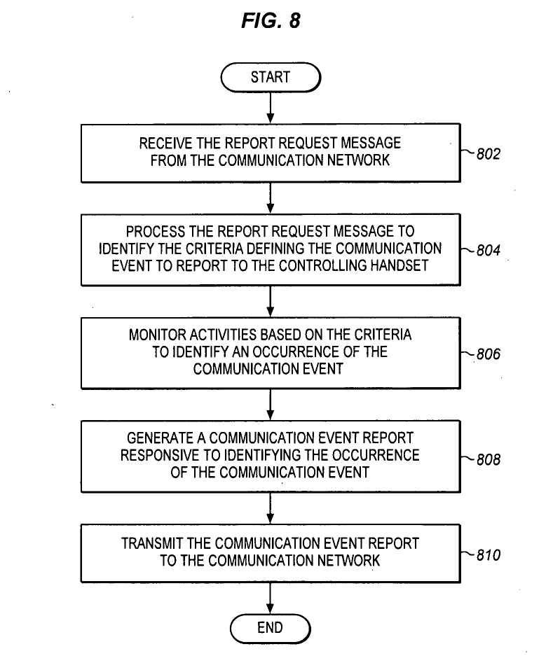

In FIG. 8, network interface 502 in reporting handset 110 receives the report request message in step 802. In step 804, reporting system 504 processes the report request message to identify the criteria defining the communication event to report to controlling handset 120. In step 806, reporting system 504 monitors activities within reporting handset 110 based on the criteria to identify an occurrence of the communication event. For example, reporting system 504 may monitor applications 508 based on the criteria to determine whether a call is being initiated, whether a call is being received, whether a text message is being sent, etc. Reporting system 504 may alternatively monitoring incoming or outgoing signaling messages through network interface 502 based on the criteria to determine whether a call is being initiated, whether a call is being received, whether a text message is being sent, etc. In step 808, reporting system 504 generates a communication event report responsive to identifying the occurrence of the communication event. In step 810, network interface 502 transmits the communication event report to communication network 100.

In FIG. 7, network element 102 receives the communication event report from reporting handset 110 responsive to the communication event occurring in reporting handset 110 in step 706. Network element 102 then transmits the communication event report to controlling handset 120 in step 708.

In FIG. 6, network interface 402 in controlling handset 120 receives the communication event report from communication network 100 in step 610. Monitoring system 404 then displays the communication event report to controlling party 122 through user interface 406 in step 612. Because controlling handset 120 receives the communication event report in response to reporting handset 110 detecting the occurrence of the communication event, controlling handset 120 in effect receives the communication event report in real time.

### EXAMPLE

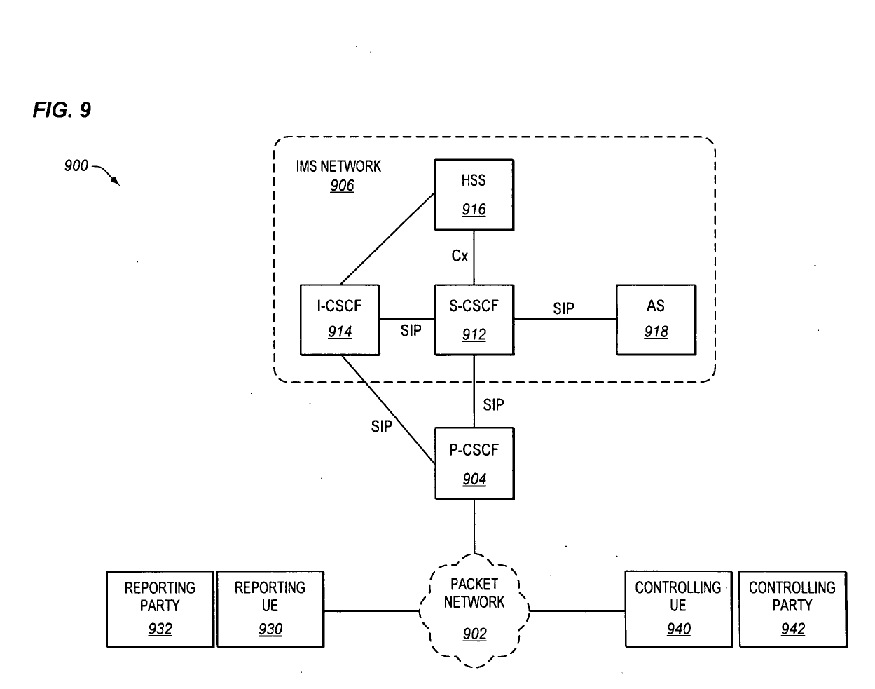

FIGS. 9-15 illustrate examples of monitoring usage of a reporting handset. FIG. 9 illustrates a communication network 900 in an exemplary embodiment of the invention. Communication network 900 includes a packet network 902, a Proxy-CSCF (P-CSCF) 904, and an IMS network 906. IMS network 906 includes an S-CSCF 912, an Interrogate-CSCF (I-CSCF) 914, an HSS 916, and an application server (AS) 918. IMS network 900 may include other network elements that are not illustrated in FIG. 9 for the sake of brevity.

A reporting UE 930 (i.e., a reporting handset) connects to IMS network 906 through packet network 902. Reporting UE 930 is operated by reporting party 932. A controlling UE 940 (i.e., a controlling handset) also connects to IMS network 906 through packet network 902. Controlling UE 940 is operated by controlling party 942. Controlling party 942 has some type of authoritative relationship with reporting party 932, and desires to monitor usage of reporting UE 930 by reporting party 932. Thus, controlling party 942 subscribes to a service provided in IMS network 906 for monitoring reporting UE 930. As part of the monitoring service, controlling party 942 defines criteria for one or more communication events that he/she wants to monitor involving reporting UE 930. Assume for one embodiment that the criteria define a communication event as initiation of a voice call to Randy Smith at directory number 303-450-XXXX. The criteria are provisioned in HSS 916, such as in a service profile for controlling party 942.

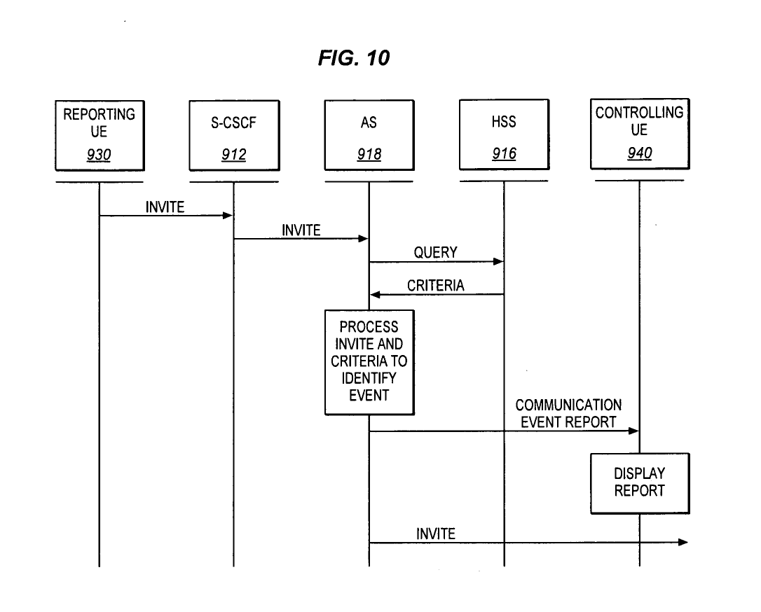

At some point of operation, reporting UE 930 registers with IMS network 906. As part of registration, S-CSCF 912 will be identified as the serving network element for reporting UE 930. Similarly, controlling UE 940 registers with IMS network 906. As part of registration, S-CSCF 912 will also be identified as the serving network element for controlling UE 940. When reporting UE 930 and controlling UE 940 register, S-CSCF 912 will download their service profiles from HSS 916. The service profile for controlling UE 940 will indicate that controlling party 942 subscribes to a monitoring service to monitor reporting UE 930. S-CSCF 912 then monitors the activities of reporting UE 930, as is illustrated in FIG. 10

FIG. 10 is a message diagram illustrating the monitoring of reporting UE 930 in an exemplary embodiment of the invention. Assume for this embodiment that reporting UE 930 initiates a voice call. To initiate the call, reporting UE 930 generates a SIP INVITE, and transmits the SIP INVITE to S-CSCF 912 through packet network 902 and P-CSCF 904. S-CSCF 912 receives the SIP INVITE and processes the INVITE to identify that the INVITE is received from reporting UE 930. For example, the INVITE includes a PUID of the sender, and S-CSCF 912 is able to identify that the INVITE is from reporting UE 930 based on the PUID. S-CSCF 912 also determines that activities from this reporting UE 930 are to be monitored, so S-CSCF 912 forwards the SIP INVITE to application server 918.

In response to the INVITE, application server 918 queries HSS 916 for the criteria defined for reporting UE 930. HSS 916 then identifies the criteria defined by controlling party 942, and transmits the criteria to application server 918. Application server 918 then processes the SIP INVITE based on the criteria defined by controlling party 942 to determine whether or not a communication event has occurred.

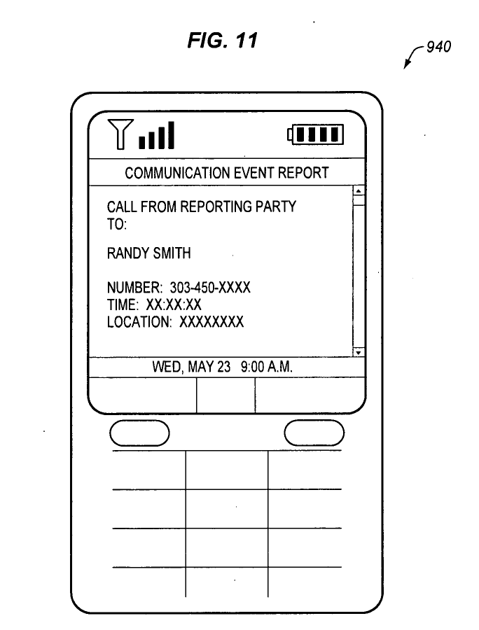

Assume that the SIP INVITE indicates that the INVITE is to initiate a voice call to Randy Smith. Based on the criteria, application server 918 determines that a communication event has occurred in response to the SIP INVITE. Thus, application server 918 generates a communication event report, and transmits the communication event report to controlling UE 940. Controlling UE 940 then displays the communication event report to controlling party 942. FIG. 11 illustrates the communication event report displayed by controlling UE 940 in an exemplary embodiment of the invention.

In FIG. 10, AS 918 routes the SIP INVITE to the destination of the call, which is Randy Smith. The voice call may then be established between reporting UE 930 and the destination.

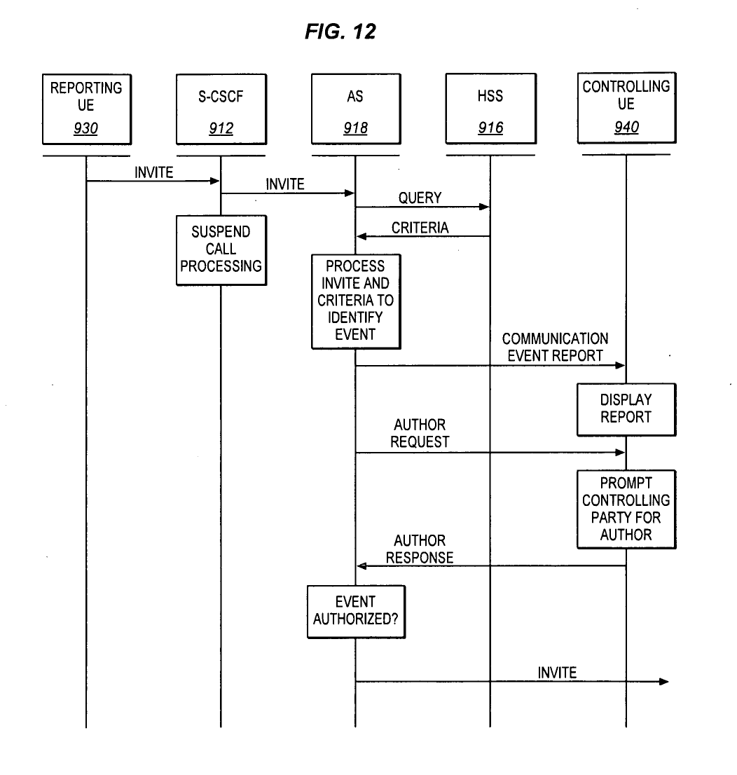

The monitoring service may allow controlling party 942 to control whether or not the communication event is allowed to continue. FIG. 12 is a message diagram illustrating the monitoring of reporting UE 930 with control by controlling party 942 in an exemplary embodiment of the invention. The message diagram in FIG. 12 is similar to FIG. 10, except that S-CSCF 912 suspends call processing after forwarding the SIP INVITE to application server 918. S-CSCF 912 may provide an announcement or send a message to reporting UE 930 and/or controlling UE 940 indicating that call processing has been suspended. After sending the communication event report to controlling UE 940, application server 918 generates an authorization request message requesting authorization of the voice call. Application server 918 then transmits the authorization request message to controlling UE 940.

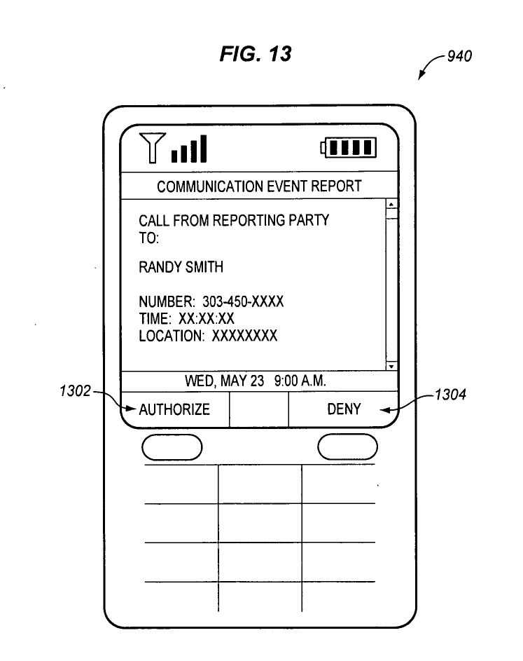

In response to the authorization request message, controlling UE 940 prompts controlling party 942 about whether the call to Randy Smith is authorized. FIG. 13 illustrates controlling UE 940 prompting controlling party 942 in an exemplary embodiment of the invention. In response to the authorization request message, controlling UE 940 displays an “authorize” icon 1302 and a “deny” icon 1304 beneath the communication event report. Controlling party 942 may then select the “authorize” icon 1302 or the “deny” icon 1304 to either authorize the call or deny the call. Based on the input from controlling party 942, controlling UE 940 generates an authorization response message, and transmits the authorization response message to application server 918.

Application server 918 receives the authorization response message from controlling UE 942 indicating whether or not the call is authorized. If the authorization response message indicates that the call is authorized, then application server 918 forwards the SIP INVITE to the destination to set up the call, as is illustrated in FIG. 12. If the authorization response message indicates that the call is not authorized, then application server 918 transmits a SIP MESSAGE to S-CSCF 912 indicating that the call is not authorized. S-CSCF 912 may then prohibit the call from being set up.

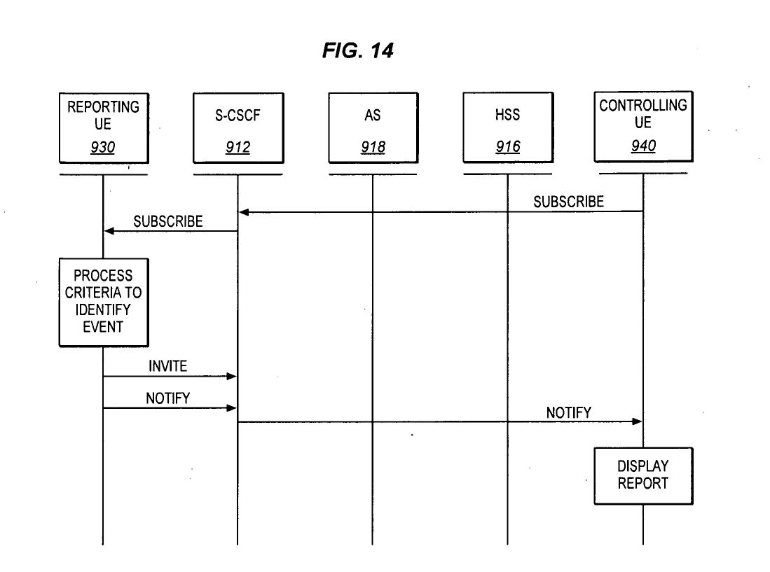

The embodiments described in FIGS. 10-13 describe the scenario where IMS network 906 monitors the activities and generates the communication event report. In another embodiment, reporting UE 930 may monitor itself and generate the communication event report, which is illustrated in FIG. 14.

FIG. 14 is a message diagram illustrating the monitoring of reporting UE 930 in an exemplary embodiment of the invention. To begin, controlling UE 940 identifies criteria defining a communication event for which controlling party 942 want to be notified. To identify the criteria, controlling UE 940 may query controlling party 942 so that controlling party 942 may dynamically define the criteria. Alternatively, the criteria may be pre-provisioned within controlling UE 940. Controlling UE 940 then generates a SIP SUBSCRIBE message requesting to be notified of the communication event, and inserts the criteria in the SIP SUBSCRIBE. Controlling UE 940 then transmits the SUBSCRIBE to S-CSCF 912. S-CSCF 912 then forwards the SIP SUBSCRIBE to reporting UE 930. The SIP SUBSCRIBE includes a PUID for reporting UE 930 in the “To” header, a PUID for controlling UE 940 in the “From” header, the report request, and the criteria.

In response to the SIP SUBSCRIBE, reporting UE 930 checks if controlling UE 940 is authorized to receive a report on communication events. For example, reporting UE 930 may be provisioned with one or more PUIDs of particular UEs that are authorized to receive reports. If controlling UE 940 is not authorized, then the report request is rejected. If controlling UE 940 is authorized, then reporting UE 930 processes the SIP SUBSCRIBE to identify the criteria defined for reporting UE 930. Reporting UE 930 then monitors its internal activities based on the criteria to identify the occurrence of any communication events. In other words, reporting UE 930 determines whether the conditions defined in the criteria are satisfied, and if so a communication event is identified.

Assume again that the criteria define a communication event as initiation of a voice call to Randy Smith at directory number 303-450-XXXX. Further assume for this embodiment that reporting UE 930 initiates a voice call. To initiate the call, reporting UE 930 generates a SIP INVITE, and transmits the SIP INVITE to S-CSCF 912 through packet network 902 and P-CSCF 904. Responsive to the SIP INVITE and based on the criteria, reporting UE 930 determines that a communication event has occurred. Thus, reporting UE 930 generates a communication event report that includes information on the communication event. Reporting UE 930 also generates a SIP NOTIFY, and inserts the communication event report in the SIP NOTIFY. Reporting UE 930 then transmits the SIP NOTIFY to S-CSCF 912. S-CSCF 912 forwards the SIP NOTIFY to controlling UE 940. Controlling UE 940 then displays the communication event report to controlling party 942 (see FIG. 11).

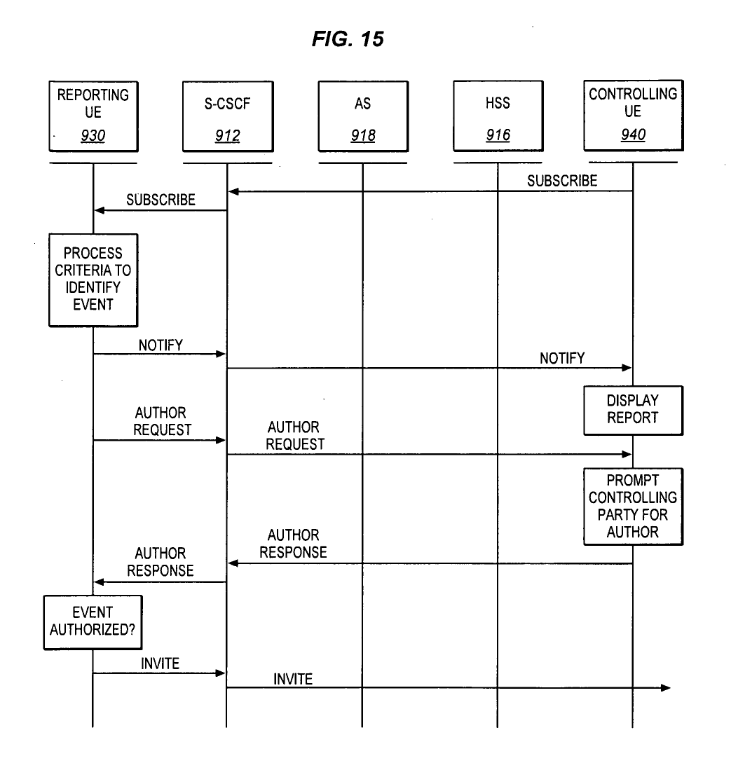

As with the prior embodiment, controlling UE 942 may be able to control whether or not the call is allowed. FIG. 15 is a message diagram illustrating the monitoring of reporting UE 930 with control by controlling party 942 in an exemplary embodiment of the invention. The message diagram in FIG. 15 is similar to FIG. 14, except that reporting UE 930 suspends call processing before sending the SIP INVITE to S-CSCF 912. After sending the SIP NOTIFY to controlling UE 940, reporting UE 930 generates an authorization request message requesting authorization of the voice call. Reporting UE 930 then transmits the authorization request message to controlling UE 940 through S-CSCF 912.

In response to the authorization request message, controlling UE 940 prompts controlling party 942 about whether the call to Randy Smith is authorized (see FIG. 13). Based on the input from controlling party 942, controlling UE 940 generates an authorization response message, and transmits the authorization response message to reporting UE 930 through S-CSCF 912.

Reporting UE 930 receives the authorization response message from controlling UE 942 indicating whether or not the call is authorized. If the authorization response message indicates that the call is authorized, then reporting UE 930 transmits the SIP INVITE to S-CSCF 912, and S-CSCF 912 forwards the SIP INVITE to the destination to set up the call, as illustrated in FIG. 15. If the authorization response message indicates that the call is not authorized, then reporting UE 930 does not transmit a SIP INVITE to S-CSCF 912 to prohibit the call from being set up.

Those skilled in the art will appreciate that any of the structural elements (e.g., handset 110, handset 120, network element 102) described herein may be implemented as hardware, software, firmware, or some combination of these. For example, a structure element may be implemented as one or more processors executing instructions that are stored on a storage media. Alternatively, a structural element may be implemented as a programmable gate array, a circuit or circuitry, logic, or some other physical electronic implementation that is not entirely software based.

Although specific embodiments were described herein, the scope of the invention is not limited to those specific embodiments. The scope of the invention is defined by the following claims and any equivalents thereof.

We claim:

1. A method of monitoring the usage of a reporting handset in real time in a communication network, the method comprising:
identifying, within the communication network, criteria defining a communication event involving the reporting handset for which a controlling handset has requested to be notified;
monitoring signaling messages for the reporting handset based on the criteria to identify an occurrence of the communication event involving the reporting handset;
generating a communication event report responsive to identifying the occurrence of the communication event involving the reporting handset; and
transmitting the communication event report to the controlling handset for display to a controlling party.

2. The method of claim 1 further comprising:
suspending, in the communication network, the identified communication event involving the reporting handset;
generating an authorization request message requesting authorization of the identified communication event;
transmitting the authorization request message to the controlling handset;
receiving an authorization response message in the communication network from the controlling handset;
permitting the identified communication event involving the reporting handset if the authorization response message indicates that the identified communication event is authorized; and
prohibiting the identified communication event involving the reporting handset if the authorization response message indicates that the identified communication event is not authorized.

3. The method of claim 2 wherein the communication event comprises initiation of a voice call.

4. The method of claim 2 wherein the communication event comprises initiation of a text/multimedia message.

5. The method of claim 1 wherein the communication network comprises an IMS network.

6. A communication network operable to monitor the usage of a reporting handset in real time, the communication network comprising:
at least one network element operable to identify criteria defining a communication event involving the reporting handset for which a controlling handset has requested to be notified;
the at least one network element further operable to monitor signaling messages for the reporting handset based on the criteria to identify an occurrence of the communication event involving the reporting handset;
the at least one network element further operable to generate a communication event report responsive to identifying the occurrence of the communication event involving the reporting handset; and
the at least one network element further operable to transmit the communication event report to the controlling handset for display to a controlling party.

7. The communication network of claim 6 wherein:
the at least one network element is further operable to suspend the identified communication event involving the reporting handset;
the at least one network element is further operable to generate an authorization request message requesting authorization of the identified communication event;
the at least one network element is further operable to transmit the authorization request message to the controlling handset;
the at least one network element is further operable to receive an authorization response message in the communication network from the controlling handset;
the at least one network element is further operable to permit the identified communication event involving the reporting handset if the authorization response message indicates that the identified communication event is authorized; and
the at least one network element is further operable to prohibit the identified communication event involving the reporting handset if the authorization response message indicates that the identified communication event is not authorized.

8. The communication network of claim 7 wherein the communication event comprises initiation of a voice call.

9. The communication network of claim 7 wherein the communication event comprises initiation of a text/multimedia message.

10. The communication network of claim 6 wherein the at least one network element comprises a Serving Call Session Control Function (S-CSCF) and an application server.

11. A method of monitoring usage of a reporting handset in a communication network, the method comprising:
receiving a report request message from a controlling handset requesting to be notified of a communication event involving the reporting handset;
transmitting the report request message to the reporting handset;
receiving a communication event report in the communication network from the reporting handset responsive to the communication event occurring in the reporting handset; and
transmitting the communication event report to the controlling handset for display to a controlling party.

12. The method of claim 11 further comprising:
suspending, in the communication network, the communication event involving the reporting handset;
generating an authorization request message requesting authorization of the communication event indicated in the communication event report;
transmitting the authorization request message to the controlling handset;
receiving an authorization response message in the communication network from the controlling handset;
permitting the communication event involving the reporting handset if the authorization response message indicates that the communication event is authorized; and
prohibiting the communication event involving the reporting handset if the authorization response message indicates that the communication event is not authorized.

13. The method of claim 11 further comprising:
receiving the report request message in the reporting handset;
processing the report request message to identify criteria defining the communication event to report to the controlling handset;
monitoring activities based on the criteria to identify an occurrence of the communication event;
generating the communication event report responsive to identifying the occurrence of the communication event; and
transmitting the communication event report from the reporting device to the communication network.

14. The method of claim 11 further comprising:
identifying criteria defining the communication event in the controlling handset;
generating the report request message, and inserting the criteria in the report request message;
transmitting the report request message to the communication network;
receiving the communication event report from the communication network; and
displaying the communication event report to a controlling party.

15. The method of claim 11 wherein the communication network comprises an IMS network.

16. A system that supports monitoring the usage of a reporting handset over a communication network, the system comprising:
a controlling handset operable to identify criteria defining a communication event involving the reporting handset, to generate a report request message requesting to be notified of the communication event involving the reporting handset, to insert the criteria in the report request message, and to transmit the report request message to the reporting handset over the communication network; and
the reporting handset operable to receive the report request message, to process the report request message to identify the criteria defining the communication event, to monitor activities based on the criteria to identify an occurrence of the communication event, to generate a communication event report responsive to identifying the occurrence of the communication event, and to transmit the communication event report to the controlling handset over the communication network;
the controlling handset further operable to receive the communication event report, and to display the communication event report to a controlling party.

17. The system of claim 16 wherein:
the reporting handset is further operable to suspend the communication event, to generate an authorization request message requesting authorization of the communication event indicated in the communication event report, to transmit the authorization request message to the controlling handset, to receive an authorization response message from the controlling handset, to permit the communication event if the authorization response message indicates that the communication event is authorized, and to prohibit the communication event if the authorization response message indicates that the communication event is not authorized.

18. The system of claim 17 wherein the communication event comprises initiation of a voice call.

19. The system of claim 17 wherein the communication event comprises initiation of a text/multimedia message.

20. The system of claim 16 wherein the communication network comprises an IMS network.
